(19) United States
(12) Patent Application Publication
(10) Pub. No.: US 2026/0329598 A1
(43) Pub. Date: Oct. 22, 2026

(54) SYSTEMS AND METHODS OF PROVIDING DYNAMIC INFORMATION

(71) Applicant: Salesforce, Inc., San Francisco, CA (US)

(72) Inventors: Tarundeep BATRA, San Francisco, CA (US); Pushkin SONKUSARE, Bengaluru (IN); Avinash KASIPATHY, Bellevue, WA (US)

(21) Appl. No.: 19/180,273

(22) Filed: Apr. 16, 2025

(51) Int. Cl. G06F 9/451

(52) U.S. Cl. CPC G06F 9/451

(57) ABSTRACT

Systems and methods are provided for displaying information generated by a server in a display. An artificial intelligence (AI) chat sidebar may be generated by the server and executed based on a first triggering event. The AI chat sidebar may receive a user query for information. The displayed information of the display may be updated based on at least the user query. The server may generate a response that includes a least a portion of the information requested by the user query. The generated response that includes a least a portion of the information requested by the user query may be displayed in the AI chat sidebar of the display. The displayed information of the display may be updated based on the generated response.

### BACKGROUND

In some current websites, an agent is displayed which can assist a user. However, content, information, and/or products displayed on the website are not updated based on interactions with the agent.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-4 show an example method of updating information, content, and/or products based on a conversation in a chat sidebar according to implementations of the disclosed subject matter.

FIGS. 5A-5B show an example displays for a least a portion of the example method of FIGS. 1-4 according to implementations of the disclosed subject matter.

FIG. 6 shows an example computer system to perform the example methods of FIGS. 1-4, and output the example displays of FIGS. 5A-5B, according to implementations of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter may provide a generative artificial intelligence (AI) chat sidebar to a webpage and/or application. The user may provide inquiries and/or responses to an agent in the AI chat sidebar which may be disposed, for example, on a right side of a display, and a left side of the display may include information, content, and/or product information. Based on the conversation between the agent and the user in the AI chat sidebar, the information for the left side of the display may be updated as the conversation occurs. If selections are made by user for particular information, content, and/or product items on the left side of the display, the agent may ask questions and/or make statements in the AI chat sidebar based on the user selection. Implementations of the disclosed subject matter improves on current systems by increasing the speed at which the user may retrieve relevant information, and/or quickly refine information provided to the user. In some implementations, the speed of providing relevant information to the user may increase by reducing the number of requests made by the user and/or by reducing the number of operations performed by the system. That is, the system increases the speed of providing relevant information while minimizing user frustration.

The system may have contextual awareness of the information presented in the display, and may provide personalization of information. That is, the systems and methods of the disclosed subject matter may use page context (i.e., the information and/or content displayed on a display that is presented to a user) and personalization contexts, such as user preferences, user information, product-centric data, and/or information-centric data when generating a display for an application and/or webpage.

In implementations of the disclosed subject matter, the AI chat sidebar may be displayed or withdrawn based on an action and/or trigger event, and/or may be configured to connect to and/or interact with other messaging platforms. Actions may be triggered during conversations between the user and an agent in the AI chat sidebar to gather context and/or address user queries and/or requests. The actions may receive input parameters, execute one or more tasks, and/or return outputs, such as displaying information, content, and/or products, and/or confirming completion of a task. That is, a triggering action in the display may execute the AI chat sidebar, which may slide into a position on the display, for example, that is on the right side. Another triggering action (e.g., based on a user selection in the display or a comment made by the user in the conversation with an agent, or the like) may cause the AI chat sidebar to slide out from its right-side position on the display so that it is no longer displayed. The slide-in and/or slide-out operation of the AI chat sidebar may be configured so that it does not interfere with the main content section of the display. The slide-in and/or slide-out operation of the AI chat sidebar may provide a smooth interface for the user to find information, products, and the like that the user is interested in without frustrating and/or interrupting the user experience.

In some implementations, the AI chat sidebar may be configured to be communicatively coupled to a messaging platform, and/or may be configured to interact with an AI and/or conversation platform.

In some implementations, suggested actions may be provided in the display, and the suggested actions may be based on context. That is, one or more actions may be provided in the display for the user based on the content and/or information presented in the display, and/or based on the conversation between the user and the agent in the AI chat sidebar.

In some implementations, the presentation of the display may be customized and/or modified. That is, the content of the display, the appearance of the AI chat sidebar (e.g., stylization theme, branding, or the like) may be adjusted (e.g., by the user, an administrator, or the like) by using page-level settings, application-level settings, or the like.

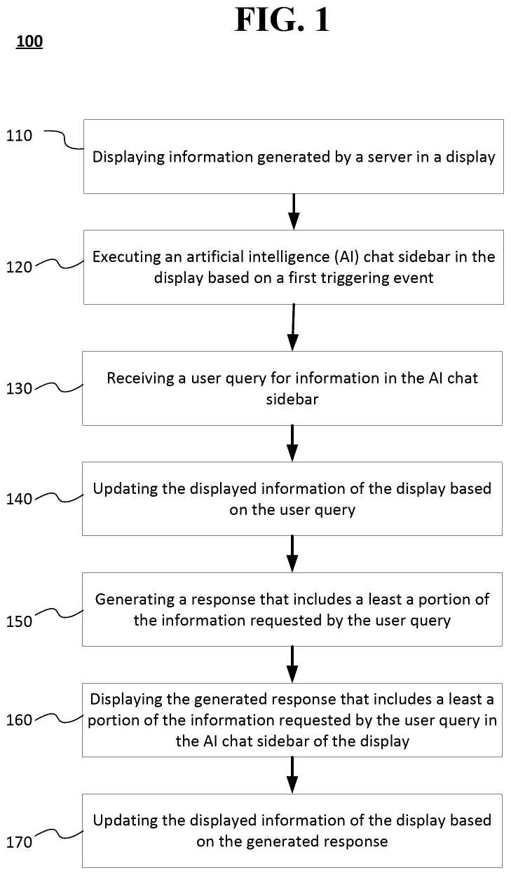

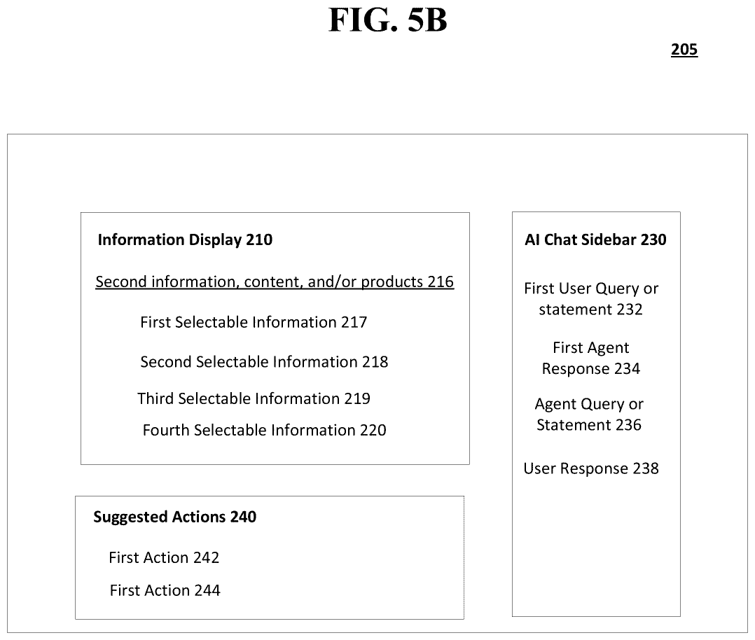

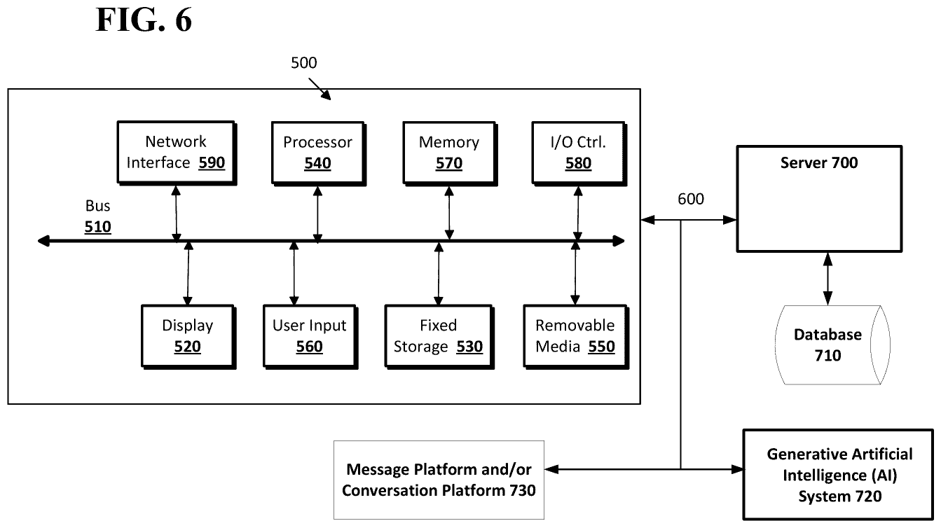

FIGS. 1-4 show an example method 100 of using a generative artificial intelligence (AI) chat sidebar to quickly retrieve relevant information, and/or refine what information is provided according to implementations of the disclosed subject matter. At operation 110, information that is generated by a server (e.g., server 700 shown in FIG. 6) may be displayed in a display (e.g., display screen 200 shown in FIG. 5A, which may be presented on display 520 of computer 500 of the user). The information generated by the server at operation 110 may include information, content, and/or products (e.g., information, content, and/or products 212 shown in information display 210 of display 200 of FIG. 5A).

At operation 120, an artificial intelligence (AI) chat sidebar generated by the server may be executed in the display based on a first triggering event. As described below, the triggering event may cause the AI chat sidebar to perform a slide-in operation to a display. A portion of the display (e.g., a left side of the display) may include content, product, information, and the like, and another portion of the display (e.g., the right side of the display) may include the AI chat sidebar. That is, the display 200 of FIG. 5A may display AI chat sidebar 230 when a triggering event occurs. The AI chat sidebar may enable conversations between an agent and a user, where the user may ask questions to retrieve information, content, products, and the like that the user is interested in.

At operation 130, the AI chat sidebar may receive a user query for information. For example, the user may enter first user query or statement 232 in the AI chat sidebar 230 of the display 200 as shown in FIG. 5A. The user query may request information, content, products, or the like that the user is interested in. Based on at least the user query, the server may update the displayed information of the display at operation 140. For example, the content, information, and/or products displayed on the left side of the display may be updated by the server based on the user query and/or the context of the information, content, and/or products displayed before the user provided the query. As shown in FIG. 5A, the first information, content, and/or products 212 may be displayed before receiving the first user query or statement 232 in the AI chat sidebar 230. Upon receipt of the first user query or statement 232, the information display 210 may display first selectable information and/or second selectable information 214.

At operation 150, the server may generate a response that includes at least a portion of the information requested by the user query. For example, the first agent response 234 in the AI chat sidebar 230 may be in response to the first user query or statement 232. The generated response that includes a least a portion of the information requested by the user query may be displayed in the AI chat sidebar of the display at operation 160, and the displayed information of the display may be updated based on the generated response at operation 170. For example, the second information, content and/or products 216, which may include first selectable information 217 and/or second selectable information 218 as shown in display 205 of FIG. 5B may be displayed based on the first agent response 234. That is, the generated response may be presented by the agent in the AI chat sidebar on the right side of the display, and/or the information displayed in content, information, and/or products may be updated on the left side of the display in at least a portion of the response to the user query.

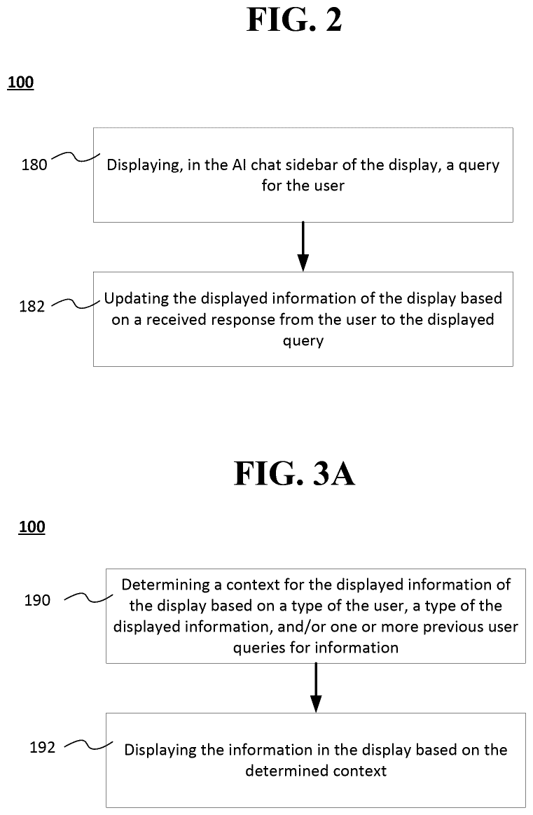

FIG. 2 shows optional operations of method 100 according to an implementation of the disclosed subject matter. At operation 180, a query for the user that is generated by the server may be displayed in the AI chat sidebar of the display. That is, the server may generate a query to be presented by the agent in the AI chat sidebar. This may be in response to an earlier query and/or statement made by the user in the AI chat sidebar. For example, agent query or statement 236 may be generated and displayed in AI chat sidebar 230 of display 205 shown in FIG. 5B. At operation 182, the server may update the information displayed in the display. For example, the update to the display may be based on a received response from the user to the displayed query, and may include one or more updates to the information, content, and/or products displayed on the left side of the display. As shown in FIG. 5B, third selectable information 219 and/or fourth selectable information 220 may be displayed in information display 210 based on the user response 228 that is in response to the agent query or statement 236.

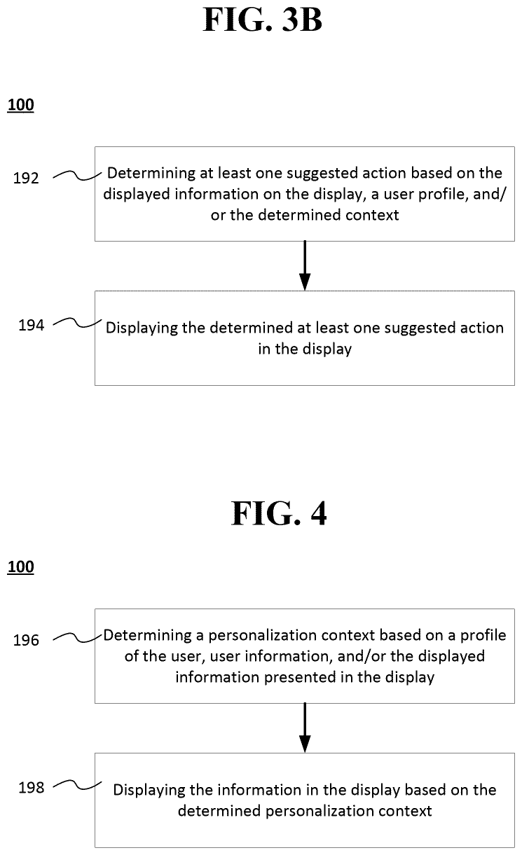

FIG. 3A shows optional operations of method 100 according to an implementation of the disclosed subject matter. At operation 190, the server may determine a context for the displayed information of the display based on a type of the user, a type of the displayed information, and/or one or more previous user queries for information. For example, the user server may determine the context of the information display 210, which may include first selectable information 213 and/or second selectable information 214, as shown in FIG. 5A, which was displayed in response to the first user query or statement 232. That is, the context may be displayed based on the dialogue between user and agent in the AI chat sidebar, the profile of the user, and the information presented in the display. At operation 192, the server may display the information in the display based on the determined context. In this example, the server may display second information, content, and/or products 216 that may include first selectable information 217, second selectable information 218, third selectable information 219, and/or fourth selectable information 220 based on the determined context.

That is, the type of the user may include a profile of the user, which may include previous information and/or content viewed by the user, the types of products viewed and/or purchased by a user, user preferences related to content, information, and/or products, and the like. These user attributes may be used by the server to determine what information, content, and/or products to display for the user on the left side of the display based on one or more queries and/or statements made by the user in the AI chat sidebar. The AI chat sidebar may use contextual awareness to determine user behavior and/or preferences. In some implementations, the generative AI system 720, the message platform and/or conversation platform 730, and/or the server 720 may determine the user behavior and/or preferences based on context. Using this information, the system may present information, products, content, and the like to the user on the left side of the display, and/or may suggest search refinements in the AI chat sidebar on the right side of the display. The system may update page results dynamically (e.g., to the content, products, information, or the like displayed on the right side of the display) based on conversation responses in the AI chat sidebar (e.g., on the left side of the display).

FIG. 3B shows additional operations that may be performed by method 100 after the operations shown in FIG. 3A according to implementations of the disclosed subject matter. At operation 192, the server may determine at least one suggested action based on the displayed information on the display, a user profile, and/or the determined context. At operation 194, the server may display the determined at least one suggested action in the display. For example, FIG. 5B shows suggested actions 240, which may include first action 242 and second action 244, which may be selectable by the user. The suggested actions may include, for example: an action to present information, content, and/or products of a different category, in the display 205; an action to purchase the information, content, and/or products (e.g., informational products and/or content; physical products, services, and the like); an action to perform a different search; an action to track an order, or the like. Based on the information, content and/or products 216 displayed in information display 210, the profile of the user, the determined context (e.g., the queries and/or statements made by the user and/or agent in sidebar 230), the server may generate suggested actions 240 that the user may select.

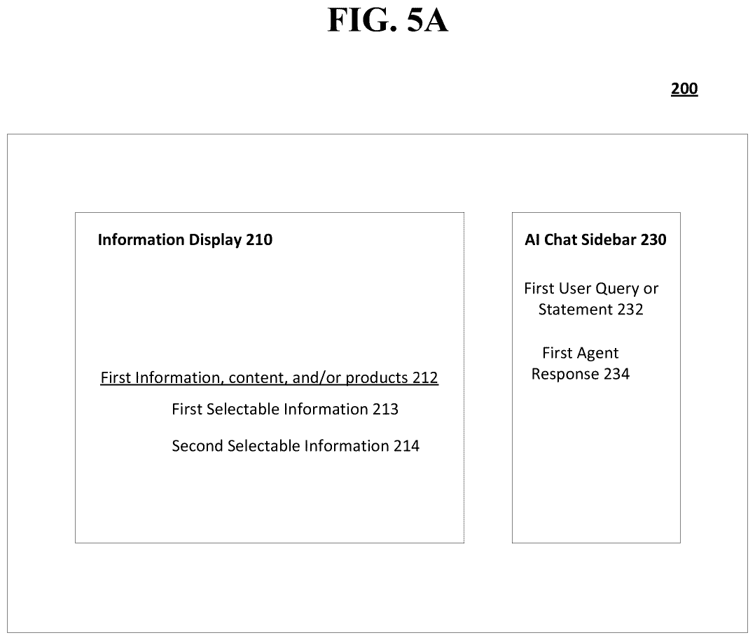

FIG. 4 shows additional operations that may be performed by method 100 according to implementations of the disclosed subject matter. At operation 196, the server may determine a personalization context based on a profile of the user, user information, and/or the displayed information presented in the display. At operation 198, the server may display the information in the display based on the determined personalization context. The personalization context may include previous information and/or content viewed by the user, the types of products viewed and/or purchase by a user, user preferences related to content, information, and/or products, and the like. For example, the first information, content, and/or products 212 displayed in display 200 shown in FIG. 5A and/or the second first information, content, and/or products 216 displayed in display 205 shown in FIG. 5B may be based on the determined personalization context.

Method 100 may include other optional operations that are not shown in FIGS. 1-4. For example, in some implementations, the server may customize the displayed information in the display based on at least one selected setting for the display. For example, the content of the display, the appearance of the AI chat sidebar (e.g., stylization theme, branding, or the like) may be adjusted (e.g., by the user, an administrator, or the like) by using page-level settings, application-level settings, or the like. For example, the appearance of the information display 210 that provides the first information, content, and/or products 210 shown in FIG. 5A and/or the second information, content, and/or products 216 shown in FIG. 5B may be adjusted, and/or the appearance of the AI chat sidebar 230 may be adjusted.

In some implementations, the server may remove the AI chat sidebar from the display based on a second triggering event. While the first triggering event may slide the AI chat sidebar into a position on the display (e.g., slide AI chat sidebar 230 on the right side of the display 200 or 205), the second triggering action (e.g., based on a user selection in the display or a comment made by the user in the conversation with an agent, or the like) may cause the AI chat sidebar to slide out from its right-side position on the display so that it is no longer displayed (e.g., the AI chat sidebar 230 of the display 200 or 205 may be removed from the display 200 and/or 205). For example, the second trigging event may be a user selection of one or more items of information, content, and/or products on the left side of the display. The user may select first selectable information 213 and/or second selectable information 214 from first information, content and/or products 212 as shown in FIG. 5A, and/or may select first selectable information 217, second selectable information 218, third selectable information 219, and/or fourth selectable information 220 from second information, content and/or products 216 as shown in FIG. 5B. In another example, a user statement in the AI chat sidebar (e.g., user response 238 in the AI chat sidebar 230 shown in FIG. 5B) may be the second triggering event that may cause the AI chat sidebar to slide out from its right-side position on the display so that it is no longer displayed.

In some implementations, the AI chat sidebar may be communicatively coupled with a message platform and/or a conversation platform. For example, FIG. 6 shows message platform and/or conversation platform 730 communicatively coupled to server 700 and/or generative AI system 720 via communications network 600. In some implementations, the message platform and/or the conversation platform may be provided by the server (e.g., server 700) or a second server (e.g., that may be communicatively coupled to communications network 600 shown in FIG. 6). This connection with a message platform and/or other conversation platform may expand and/or enable different functionalities of the AI chat sidebar. For example, the message platform and/or conversation platform 730 may be used to determine the user behavior and/or preferences based on context, as described above. In another example, the message platform and/or conversation platform 730 may be used to determine a response to a user query, engage the user in a conversation, ask the user questions based on statements made by the user in the AI chat sidebar, or the like.

In some implementations, the response times of the AI chat sidebar for AI interactions may be monitored to determine whether the response times are within predetermined limits. For example, the server 700 may determine whether the AI system 720 shown in FIG. 6 provides responses for the AI chat sidebar (e.g., AI chat sidebar 230 shown in FIGS. 5A-5B) based on user comments and/or inquiries within a predetermined period of time. In some implementations, the server may determine the time for slide-in and/or slide-out operations of the AI chat sidebar (e.g., slide-in or slide-out of AI chat sidebar 230 in display 200 and/or display 205 shown in FIGS. 5A-5B), and whether the determined time is within a predetermined time period.

Implementations of the disclosed subject matter may track how frequently the user selects updated content, information, and/or products based on the user's conversation with the agent in the AI chat sidebar. For example, the server 700 shown in FIG. 6 may determine the relevance of the AI-generated responses based on, for example, the user selection of information, content, and/or products (e.g., first selectable information 213 and/or second selectable information 214, as shown in FIG. 5A, and/or first selectable information 217, second selectable information 218, third selectable information 219, and/or fourth selectable information 220 shown in FIG. 5B) that have been displayed and selected by the user based on the conversations between the user and the agent in the AI chat sidebar 230.

Implementations of the disclosed subject matter may be implemented in and used with a variety of component and network architectures. FIG. 6 shows an example computer 500 may allow a user to interact with the server 700 (or one or more other servers communicatively coupled to communications network 600) that is suitable for the operations detailed in FIGS. 1-4, and which may output the displays shown in FIGS. 5A-5B. Although one server 700 is shown in FIG. 6, there may be a plurality of servers communicatively coupled to communications network 600 to perform the operations detailed in FIGS. 1-5 and output the displays shown in FIGS. 5A-5B. The computer 500 may be a single computer in a network of multiple computers.

In some implementations, the computer 500 may communicate with and may be used to receive one or more responses generated by server 700, database 710, generative AI system 720, and/or message platform and/or conversation platform 730. The server 700, generative AI system 720, and/or message platform and/or conversation platform 730 may be one or more hardware servers, virtual machines, cloud servers, databases, clusters, application servers, neural network systems, processors, devices, computers, or the like. The database 710 may use any suitable combination of any suitable volatile and non-volatile physical storage mediums, including, for example, hard disk drives, solid state drives, optical media, flash memory, tape drives, registers, and random access memory, or the like, or any combination thereof. The database 710 may store data, such as tenant data for an application, user data, user profile data, metadata, application data, and the like.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random-access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks. The service resource 404 and/or one or more user devices 750 may have components that are similar to the computer 500 described above.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “displaying”, “executing”, “receiving”, “updating”, “generating”, “determining”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general-purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

In various implementations, the models and/or modules described herein may be classification, predictive, generative, conversational, or another form of artificial intelligence (AI) technology, such as AI model(s), agents, large language models (LLMs), etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a processor or a central processing unit (CPU) coupled to one or more storage system(s), non-transitory machine readable medium(s), memory, or other machine readable storage medium(s).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
displaying information generated by a server in a display;
executing, in the display, an artificial intelligence (AI) chat sidebar generated by the server based on a first triggering event;
receiving, in the AI chat sidebar, a user query for information;
updating the displayed information of the display based on at least the user query;
generating, at the server, a response that includes a least a portion of the information requested by the user query;
displaying the generated response that includes a least a portion of the information requested by the user query in the AI chat sidebar of the display; and
updating the displayed information of the display based on the generated response.

2. The method of claim 1, further comprising:
displaying, in the AI chat sidebar of the display, a query for the user that is generated by the server; and
updating the displayed information of the display based on a received response from the user to the displayed query.

3. The method of claim 1, further comprising:
determining, at the server, a context for the displayed information of the display based on at least one selected from a group consisting of: a type of the user, a type of the displayed information, and one or more previous user queries for information; and
displaying the information in the display based on the determined context.

4. The method of claim 3, further comprising:
determining, at the server, at least one suggested action based on at least one selected from a group consisting of: the displayed information on the display, a user profile, and the determined context; and
displaying the determined at least one suggested action in the display.

5. The method of claim 1, further comprising:
determining, at the server, a personalization context based on at least one selected from a group consisting of: a profile of the user, user information, and the displayed information presented in the display; and
displaying the information in the display based on the determined personalization context.

6. The method of claim 1, further comprising:
customizing the displayed information in the display based on at least one selected setting for the display.

7. The method of claim 1, further comprising:
removing the AI chat sidebar from the display based on a second triggering event.

8. The method of claim 1, further comprising:
communicatively coupling the AI chat sidebar with at least one selected from a group consisting of: a message platform, and a conversation platform provided by the server or a second server.

9. A system comprising:
a server including at least one hardware processor, the server configured to:
display information generated by a server in a display;
execute, in the display, an artificial intelligence (AI) chat sidebar generated by the server based on a first triggering event;
receive, in the AI chat sidebar, a user query for information;
update the displayed information of the display based on at least the user query;
generate a response that includes a least a portion of the information requested by the user query;
display the generated response that includes a least a portion of the information requested by the user query in the AI chat sidebar of the display; and
update the displayed information of the display based on the generated response.

10. The system of claim 9, wherein the server is further configured to:
display, in the AI chat sidebar of the display, a query for the user that is generated by the server; and
update the displayed information of the display based on a received response from the user to the displayed query.

11. The system of claim 9, wherein the server is further configured to:
determine a context for the displayed information of the display based on at least one selected from a group consisting of: a type of the user, a type of the displayed information, and one or more previous user queries for information; and
display the information in the display based on the determined context.

12. The system of claim 11, wherein the server is further configured to:
determine at least one suggested action based on at least one selected from a group consisting of: the displayed information on the display, a user profile, and the determined context; and
display the determined at least one selected action in the display.

13. The system of claim 9, wherein the server is further configured to:
determine a personalization context based on at least one selected from a group consisting of: a profile of the user, user information, and the displayed information presented in the display; and
display the information in the display based on the determined personalization context.

14. The system of claim 9, wherein the server is further configured to customize the displayed information in the display based on at least one selected setting for the display.

15. The system of claim 9, wherein the server is further configured to removing the AI chat sidebar from the display based on a second triggering event.

16. The system of claim 9, wherein the server is further configured to communicatively couple the AI chat sidebar with at least one selected from a group consisting of: a message platform, and a conversation platform provided by the server or a second server.
